(19) United States
(12) Patent Application Publication
(10) Pub. No.: US 2017/0013791 A1
(43) Pub. Date: Jan. 19, 2017

(54) FRUIT ENVELOPE HAVING OPENING PART AND METHOD OF MANUFACTURING THE ENVELOPE

(71) Applicant: NEULPOOREUN NAMU CO., LTD., Cheonan-si (KR)

(72) Inventor: Jae Hee JUNG, Asan-si (KR)

(21) Appl. No.: 15/255,485

(22) Filed: Sep. 2, 2016

Related U.S. Application Data
(63) Continuation of application No. PCT/KR2016/006934, filed on Jun. 29, 2016.

(30) Foreign Application Priority Data
Jul. 13, 2015 (KR) 10-2015-0098875

(51) Int. Cl. A01G 13/02; B65D 33/20; B31B 41/00; B65D 30/08

(52) U.S. Cl. CPC A01G 13/0237; B65D 31/04; B65D 33/20; B31B 41/00; B31B 2241/00

(57) ABSTRACT

A fruit bag having a body and an entrance formed on the body to insert young fruit thereinto, the body having a front surface, a back surface, and side surfaces is provided. The fruit bag includes: a cover protruding from the front surface to cover the entrance; multiple folding portions formed by folding each side surface at least one or more times; and an opening part attached to the form of a band to the end portion of the body forming the entrance and having flat portions attached to the front surface and the back surface and grasping portions attached to the side surfaces, the grasping portions forming hinges together with the multiple folding portions so that if a pressure is applied to the grasping portions, the entrance is expanded by means of the flat portions.

### CROSS-REFERENCE TO RELATED APPLICATION

This application is a continuation of PCT Patent Application No. PCT/KR2016/006934 filed on Jun. 29, 2016, which claims priority to and the benefit of Korean Patent Application No. 10-2015-0098875 filed on Jul. 13, 2015, and the entire disclosures of which are incorporated herein by reference.

### BACKGROUND OF THE INVENTION

Field of the Invention

The present invention relates to a fruit bag, and more particularly, to a fruit bag having an opening part capable of opening and closing the entrance thereof and to a method for manufacturing the same.

Background of the Related Art

A method for packing young fruit with a fruit bag enables the young fruit to be sorted out and then grow under a worker's care through the accommodation in the fruit bag, so that the unnecessary distribution of nutrients can be suppressed to allow the nutrients to be collected to the young fruit accommodated in the fruit bag. Through the use of the fruit bag, the young fruit can be protected from agricultural chemical contamination and damages caused by diseases, insects, birds, worms, and so on. Further, the formation of marks on the surface of the fruit can be prevented, and through the control of the solar radiation, a high quality of fresh fruit can be produced. So as to accommodate the young fruit in the fruit bag, in conventional practices, the fruit bag binds up through a steel wire, thereby undesirably causing the instability of work and the consumption of labor force.

Conventional methods for coupling the entrance of a fruit bag using a synthetic resin structure like separate clips are disclosed in Korean Patent No. 10-1225095 and No. 10-1421680. According to the conventional methods, however, hinges and protrusions are needed to cause the structure to be more complicated, thereby giving no economical advantages, and further, the space in which the young fruit grows is not sufficiently ensured. Also, the weight of the fruit bag is heavy so that it may easily fall together with the fruit. In the process where the young fruit is inserted into the fruit bag or the matured fruit is packed with the fruit bag, further, the surface of the fruit may be damaged due to the protrusions. In the state where the clips are coupled to the fruit bag, the entrance of the fruit bag is not completely closed, thereby undesirably causing rainwater or foreign matters to enter the fruit bag. Furthermore, the clips are not easily separated and collected, so that if they are left, environmental pollution may be caused.

Another fruit bag is disclosed in Korean Utility Model Registration No. 20-0404421, wherein an adhesive tape protected by release paper is attached to the top portion of the front surface of the fruit bag, and if a cover is folded, the cover is fixedly attached to the adhesive tape from which the release paper has been removed. According to the conventional fruit bag, by the way, if the young fruit is inserted into the fruit bag, the front surface and the cover at which the adhesive tape is located become wrinkled and deformed. The wrinkles and deformation are formed even on the adhesive tape, so that the cover cannot be gently attached to the adhesive tape. Due to the formation of the wrinkles and deformation, the cover is not attached at a right position to the adhesive tape, the space into which foreign matters are invaded is formed, or the cover gets separated after a given period of time.

### SUMMARY OF THE INVENTION

Accordingly, the present invention has been made in view of the above-mentioned problems occurring in the prior art, and it is an object of the present invention to provide to a fruit bag having an opening part and a method for manufacturing the same that are capable of being simply configured to provide economical advantages, easily ensuring a space in which fruit grows, providing a light weight to prevent falling together with the fruit, preventing the surfaces of young fruit and matured fruit packed therewith from being damaged, completely closing the entrance thereof to prevent rainwater or foreign matters from entering the fruit bag, being easily collected, being eco-friendly, and preventing wrinkles and deformation from occurring thereon.

To accomplish the above-mentioned object, according to a first aspect of the present invention, there is provided a fruit bag having a body and an entrance formed on the body to insert young fruit thereinto, the body having a front surface, a back surface, and side surfaces, the fruit bag including: a cover protruding from the front surface to cover the entrance; multiple folding portions formed by folding each side surface at least one or more times; and an opening part attached to the form of a band to the end portion of the body forming the entrance and having flat portions attached to the front surface and the back surface and grasping portions attached to the side surfaces.

According to the first aspect of the present invention, desirably, the cover has a stem insertion portion formed thereon, the stem insertion portion having a cut portion formed by means of cutting the cover, and if a pressure is applied to the grasping portions, the entrance is expanded by means of the flat portions.

According to the first aspect of the present invention, desirably, the cover is extended from the back surface, and otherwise, the cover is formed unitarily with the opening part. Further, the opening part defines a folding line along which the cover is folded. The opening part is attached to the body wrinkled and deformed when the pressure is applied to the body. The distance between the front and rear side grasping portions becomes expanded toward the starting points of the grasping portions from the end portion thereof. The opening part has a ruled line formed on the grasping portion and an expansion portion extended from the portion in which the ruled line is formed. The stem insertion portion has a stem insertion hole connected to the slantly formed cut portion to insert the stem of the young fruit thereinto. The opening part has an extension portion extended therefrom, the extension portion having a hole formed to allow the stem insertion hole to be located thereinto.

To accomplish the above-mentioned object, according to a second aspect of the present invention, there is provided a fruit bag having a body and an entrance formed on the body to insert young fruit thereinto, the body having a front surface, a back surface, and side surfaces, the fruit bag including: a cover protruding from the front surface to cover the entrance; multiple folding portions formed by folding each side surface at least one or more times and serving as hinges in such a manner as to be bonded to the front surface and the back surface; and an opening part attached to the form of a band to the end portion of the body forming the entrance and having flat portions attached to the front surface and the back surface in such a manner as to place the side surfaces therebetween.

According to the second aspect of the present invention, desirably, the cover has a stem insertion portion formed thereon, the stem insertion portion having a cut portion formed by means of cutting the cover, and the portions of the flat portions coming into contact with the side surfaces form grasping portions, so that if a pressure is applied to the grasping portions, the entrance is expanded by means of the flat portions. The opening part has a bonding portion formed on the flat portion of the front surface thereof and a release layer formed on the flat portion of the back surface thereof. When the cover is bonded to the front surface, the flat portion of the front surface of the opening part is located at the inside of the bonding portions.

To accomplish the above-mentioned object, according to a third aspect of the present invention, there is provided a method for manufacturing a fruit bag, the method including the steps of: manufacturing an original fruit bag having a cover; forming multiple folding portions on side surfaces of the original fruit bag, a body having a front surface, a back surface, and side surfaces, and an entrance formed on the body to insert young fruit thereinto; forming bonding portions on the cover or the front surface; attaching a band type opening part to the end portion of the body forming the entrance, the opening part having flat portions attached to the front surface and the back surface and grasping portions bonded to or contacted with the side surfaces; and forming a cut portion by cutting a portion of the cover extended from the back surface.

To accomplish the above-mentioned object, according to a fourth aspect of the present invention, there is provided a method for manufacturing a fruit bag, the method including the steps of: manufacturing an original fruit bag; forming multiple folding portions on side surfaces of the original fruit bag, a body having a front surface, a back surface, and side surfaces, and an entrance formed on the body to insert young fruit thereinto; forming an opening structure having a band type opening part and a cover extended from the opening part to cover the entrance, the opening part having flat portions and grasping portions; attaching the opening structure to the form of a band to the end portion of the body forming the entrance, the flat portions being attached to the front surface and the back surface and the grasping portions being bonded to or contacted with the side surfaces; and forming a cut portion by cutting a portion of the cover.

According to the third or fourth aspect of the present invention, desirably, the method further includes the step of forming a release layer on at least any one of the flat portion of the front surface of the opening part and the flat portion of the back surface of the opening part.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a fruit bag according to a first embodiment of the present invention;

FIG. 2 is a plan view showing the fruit bag of FIG. 1 viewed in a direction of an entrance thereof;

FIG. 3 is a photograph showing the process for inserting young fruit into a conventional fruit bag and the fruit bag according to the first embodiment of the present invention;

FIG. 4 is a photograph showing the process for inserting the young fruit into the fruit bag according to the first embodiment of the present invention, wherein the opening part of the fruit bag is changed in position;

FIG. 5 is front views showing variations of the opening part of the fruit bag according to the first embodiment of the present invention;

FIG. 6 is a plan view showing the fruit bag according to the first embodiment of the present invention viewed from the entrance thereof so as to explain the process for inserting the young fruit into the fruit bag;

FIG. 7 is a photograph showing the process for inserting the young fruit into the fruit bag of FIG. 6;

FIG. 8 is photographs showing the scratches occurring on the young fruit before and after the young fruit is inserted into the fruit bag according to the first embodiment of the present invention;

FIG. 9 is a plan view showing an example of multiple folding portions of the fruit bag according to the first embodiment of the present invention;

FIG. 10 is a plan view showing another example of the multiple folding portions of the fruit bag according to the first embodiment of the present invention;

FIG. 11 is a plan view showing a yet another example of the multiple folding portions of the fruit bag according to the first embodiment of the present invention;

FIG. 12 is a plan view showing a variation of the fruit bag according to the first embodiment of the present invention;

FIG. 13 is a plan view showing another variation of the fruit bag according to the first embodiment of the present invention;

FIG. 14 is a perspective view showing a fruit bag according to a second embodiment of the present invention;

FIG. 15 is a plan view showing an example of multiple folding portions of the fruit bag according to the second embodiment of the present invention;

FIG. 16 is a plan view showing another example of the multiple folding portions of the fruit bag according to the second embodiment of the present invention;

FIG. 17 is a perspective view showing a fruit bag according to a third embodiment of the present invention;

FIG. 18 is a front view showing an opening structure of the fruit bag of FIG. 17;

FIG. 19 is a perspective view showing a fruit bag according to a fourth embodiment of the present invention;

FIG. 20 is a plan view showing a fruit bag according to a fifth embodiment of the present invention;

FIG. 21 is a sectional view showing a fruit bag according to a sixth embodiment of the present invention;

FIG. 22 is a flow chart showing the process for manufacturing the fruit bag according to the present invention; and

FIG. 23 is a perspective view showing the state wherein the fruit packed with the fruit bag according to the present invention becomes matured.

### DETAILED DESCRIPTION OF THE PREFERRED EMBODIMENTS

Hereinafter, an explanation on a fruit bag according to preferred embodiments of the present invention will be in detail given with reference to the attached drawing. Before the present invention is disclosed and described, it is to be understood that the disclosed embodiments are merely exemplary of the invention, which can be embodied in various forms. Therefore, the embodiments disclosed herein are provided to allow the present invention to be more perfectly appreciated by the person skilled in the art.

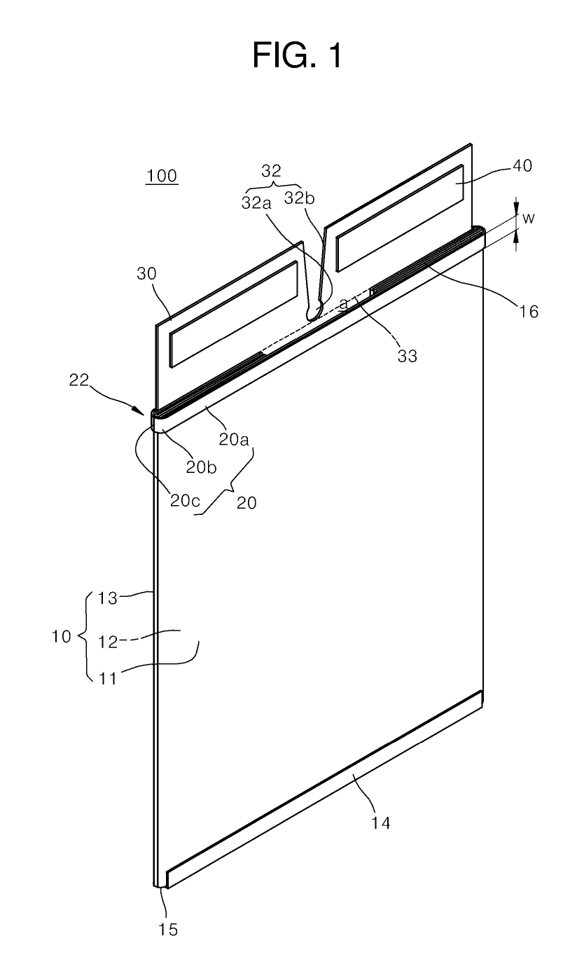

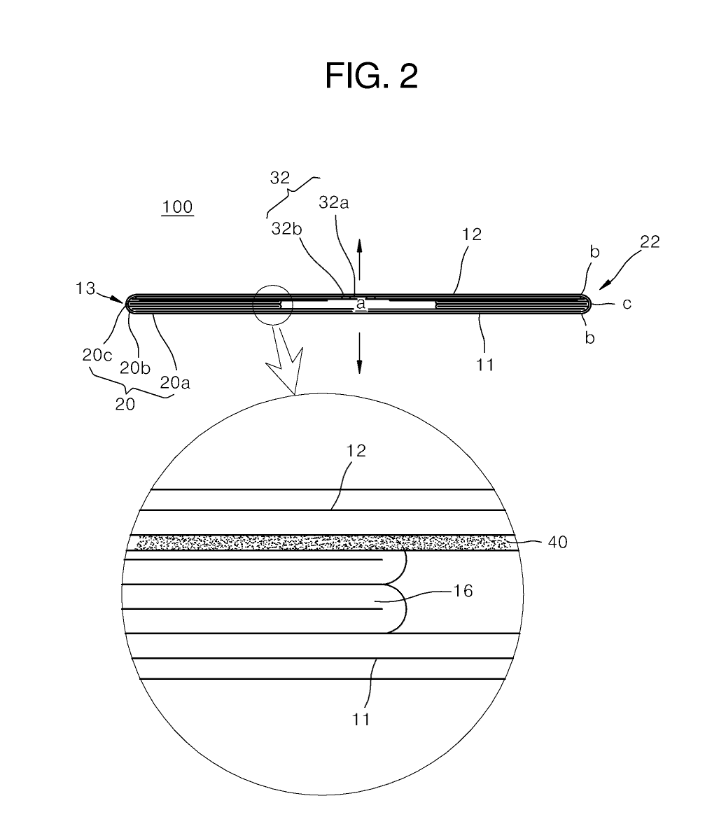

FIG. 1 is a perspective view showing a fruit bag according to a first embodiment of the present invention, and FIG. 2 is a plan view showing the fruit bag of FIG. 1 viewed in a direction of an entrance thereof.

As shown in FIGS. 1 and 2, a fruit bag 100 according to a first embodiment of the present invention includes a rectangular parallelepiped-shaped body 10 having a front surface 11, a back surface 12, and side surfaces 13. Further, the fruit bag 100 includes a cover 30 extended from the back surface 12 of the body 10. The front surface 11 and the back surface 12 form a given space in which young fruit is insertedly put, and the end portion of the front surface 11 defines an entrance a of the fruit bag 100. If the cover 30 is folded along a folding line 33, it is bonded to the front surface 11, so that the entrance a of the fruit bag 100 is closed and not exposed to the outside. Each side surface 13 is folded at least one time. Particularly, portions of each side surface 13 folded one or more times become multiple folding portions 16. In the drawing, the multiple folding portions 16 are formed through folding of each side surface 13 two times. The folded portions of the multiple folding portions 16 are freely extended toward the center portion of the fruit bag 100, and of course, they may be extended close to the center thereof.

Further, the fruit bag 100 according to the first embodiment of the present invention includes a bottom bonding portion 14 extended from the back surface 12 in such a manner as to be bonded to the bottom end thereof and at least one drain portion 15 formed on the bottom end thereof to discharge internal moisture to the outside. In the drawing, two drain portions 15 are formed. The drain portions 15 are formed to a shape of a hole, and otherwise, they may be formed naturally by the spaces formed between the bottom bonding portion 14 and the side surfaces 13. According to the present invention, the naturally formed drain portions 15 are adopted. Instead of the bottom bonding portion 14, on the other hand, the bottom ends of the front surface 11 and the back surface 12 except the drain portions 15 are bonded to each other. In this case, the sealed portion of the bottom end of the fruit bag 100 is not exposed to the outside of the fruit bag 100.

The cover 30 is extended from the back surface 12 and protrudes from the front surface 11 in such a manner as to allow the protruding portion to be separated into both sides around a stem insertion portion 32. The stem insertion portion 32 has a stem insertion hole 32a formed thereon in such a manner as to allow the folding line 33 to be at least located therein and a cut portion 32b cut from the stem insertion hole 32a. The stem insertion hole 32a is formed by punching a portion of the cover 30 to the shape of a hole, and the shape of the hole includes a circle, a polygon, and the like. As shown, desirably, the shape of the hole is the circle corresponding to the shape of the stem of the young fruit. Accordingly, the stem of the young fruit is exposed to the outside of the fruit bag 100 through the stem insertion hole 32a.

At least a portion of the cut portion 32b is formed slantly, thereby making it convenient to accommodate the stem of the young fruit in the entrance a. That is, the cut portion 32b is slantly formed on the entire or partial portion thereof. At this time, the slant means the cut portion 32b is inclined by a given angle toward the vertical direction to the folding line 33. In some cases, the cut portion 32b may be formed vertically with respect to the folding line 33, without any inclination.

According to the first embodiment of the present invention, the fruit bag 100 is any one selected from a paper bag like newspaper or oil paper, a synthetic resin bag, and a combination bag thereof, but of course, the fruit bag 100 is not limited particularly thereto. In some cases, the fruit bag 100 may have a thin layer made of a metal or ceramic so as to improve the functions thereof. The fruit bag 100 is made to the form of a single layer, desirably, to the form of multiple layers. So as to enhance the stiffness of the cover 30, a thin sheet, which is any one selected from paper, synthetic resin, metal and ceramic, may be attached to the cover 30. The attachment is achieved by means of bonding.

Bonding portions 40 are formed on the cover 30, on the portion of the front surface 11 covered with the cover 30, or on both of the cover 30 and the front surface 11. That is, the bonding portions 40 are formed on at least any one of the cover 30 and the front surface 11. In the drawing, the bonding portions 40 are formed on the cover 30. Each bonding portion 40 is any one selected from an adhesive material, an adhesive tape protected by release paper and having an adhesive material applied thereto, a microcapsule having an adhesive material embedded therein, and a pocket film in which an adhesive material is put. In this case, the adhesive material includes typically known adhesives.

An opening part 20 is formed to a given width W on the end portion of the body 10 forming the entrance a. The opening part 20 includes flat portions 20a bonded to the front surface 11 and the back surface 12 of the fruit bag 100 and grasping portions 20b attached to the side surfaces 13 in such a manner as to be bent therealong. In some cases, the opening part 20 further includes a ruled line 20c formed on the inside of each grasping portion 20b so as to allow the grasping portion 20b to be easily bent. The ruled line 20c is made to a concaved shape by pressing a portion of the grasping portion 20b under a given pressure. The width of the ruled line 20c is determined appropriately in accordance with the shape of each side surface 13 of the fruit bag 100 and the material of the opening part 20. Through the formation of the ruled line 20c, the grasping portion 20b is accurately bent when machined, without any swelling.

If the grasping portion 20b is fixed to each side surface 13, it naturally forms a hinge 22. The hinge 22 is any one selected from a triangular (<) hinge, a square ( [symbol] ) hinge, a round (⊂) hinge, and a combination thereof. Among them, desirably, the hinge 22 is the round hinge. The hinge 22 includes starting points b at which the grasping portion 20b starts and an end portion c of the grasping portion 20b. The end portion c of the triangular hinge or the round hinge is formed to the shape of one dot, but the end portion c of the square hinge is formed to the shape of one surface. The width between the starting points b of the grasping portion 20b is greater than that of the end portion c. That is, the distance between the front and back grasping portions 20b becomes expanded toward the starting points b from the end portion c.

In this state, if a pressure is applied to the hinge 22 toward the inner direction of the fruit bag 100, the front surface 11 and the back surface 12 located on the opening part 20 are expanded in the direction of an arrow ↑. In this case, the expansion means that the opening part 20 moves in the vertical directions to the front surface 11 and the back surface 12 to cause the space of the entrance a to be enlarged. If the front surface 11 and the back surface 12 are expanded, the entrance a becomes open to provide the space into which young fruit is inserted. However, the expansion is not limited particularly thereto. If the applied pressure is removed, the opening part 20 is returned in the opposite direction of the arrow ↑, so that the entrance a is closed to make the space disappear. The object of the fruit bag 100 is to accommodate the young fruit therein, and therefore, it is not important whether the opening part 20 is returned.

The opening part 20 has stiffness, particularly, a bending stiffness capable of being expanded by the pressures applied to the hinges 22. If the stiffness is small, the expansion does not occur. The front surface 11 and the back surface 12 of the fruit bag 100 have small stiffness, so that no expansion occurs thereon. The front surface 11 and the back surface 12 are made of a soft paper material having a relatively low thickness, and if a pressure is applied to them, they become wrinkled and deformed, without having any expansion.

The stiffness of the opening part 20 is determined upon the thickness, width and material of the opening part 20. According to the present invention, the stiffness of the opening part 20 can be controlled in various ways so that the opening part 20 can be expanded, without being wrinkled or deformed. So as to enhance the stiffness of the opening part 20, for example, the thickness of the opening part 20 is increased, and otherwise, the opening part 20 is made of a material having excellent stiffness. According to the first embodiment of the present invention, the fruit bag 100 is configured to attach the expandable opening part 20 to the non-expandable body 10. For example, the opening part 20 having a thickness in the range of about 0.2 to 0.3 mm is attached to the body 10 having a thickness of about 0.05 mm. The body 10 is bonded to the opening part 20, and if the opening part 20 is expanded, accordingly, the front surface 11 and the back surface 12 are also expanded.

According to the present invention, on the other hand, the time for opening the entrance a of the fruit bag 100 is the time for accommodating the young fruit in the fruit bag 100. Accordingly, the number of times for expanding the opening part 20 is limited to one time, but so as to ensure the stability of the quality of the fruit bag, the opening part 20 has the stiffness capable of being expanded and returned at least two to three times. The formation of the opening part 20 prevents the relatively thin body 10 from being broken or damaged. That is, the formation of the opening part 20 prevents the body 10 from being wrinkled or deformed and further keeps the body 10 from being broken or damaged. Further, the space formed by the opening part 20 can be utilized as the space for accommodating the young fruit therein. By the way, the conventional fruit bag using clips cannot utilize the space formed by the clips as the accommodation space. Accordingly, the fruit bag 100 according to the first embodiment of the present invention has a larger space in which the fruit grows than the conventional fruit bag.

The opening part 20 is made of a synthetic resin or a natural resin. The synthetic resin includes polymers such as PET (polyethylene terephthalate), PA (polyamide), PVC (polyvinyl chloride), PC (polycarbonate), and so on. The natural resin is made of natural materials, for example, paper. In some cases, a material useful to soil, like a reducible material such as iron, copper, zinc, sulfur compound, and so on, is introduced to the opening part 20, thereby improving the quality of soil. In case of paper, the stiffness of paper is weak to water, and accordingly, the surface of the paper is coated with a water repellent material such as paraffin, fluorocarbon resin, and so on.

The opening part 20 is formed by applying an adhesive to a given position of the fruit bag 100 and by then attaching the cut resin to the portion to which the adhesive is applied, and otherwise, the resin to which an adhesive is applied is cut to the shape of a tape and then attached to the given position of the fruit bag 100. In more detail, the opening part 20 may have the shape of the tape made of the resin to which the adhesive is applied. In the process for manufacturing the fruit bag 100, as a result, the formation of the opening part 20 is selected appropriately in consideration of the advantages of the process. The width W of the opening part 20 is determined appropriately within the technical scope of the present invention so as to allow the packing operation of the young fruit to be easily carried out. Desirably, the width W of the opening part 20 is in the range of 5 to 10 mm.

Desirably, the opening part 20 is made of a biodegradable material. Even if the biodegradable opening part 20 falls to the soil, it is degraded to cause no environmental pollution. The biodegradable opening part 20 is desirably paper, and in addition to the paper, it is at least one selected from the group consisting of polyesteramide, polyester carbonate, polybutyelne succinate adiphate, polybutyelne succinate, polycaprolacone, cellulose acetate, bacterial cellulose, cellulose-chitosan composite, polyactic acid, polylacton, polyglyoxylic acid, polymalic acid, polyamino acid, polysaccharide, starch, and modified starch. The biodegradable opening part 20 is at least any one selected from 3-hydroxy butyrate homo polymer, 3-hydroxy butyrate/3-hydroxy valerate co-polymer, and 3-hydroxy butyrate/4-hydroxy butyrate co-polymer. In addition to the above-mentioned materials, however, the biodegradable opening part 20 may be of course made of other materials within the scope of the present invention.

The opening part 20 is reinforced with at least one fiber having given elasticity. If the fiber having the given elasticity is disposed in the longitudinal direction of the opening part 20, it provides the given elasticity to the opening part 20. That is, if a force through which the elastic fiber is bent is removed from the elastic fiber, the elastic fiber is returned to its original state. The given elasticity occurs in the vertical direction with respect to the longitudinal direction of the elastic fiber. The elastic fiber is made of a synthetic fiber or natural fiber and has a given thickness capable of providing the given elasticity to the opening part 20. If a pressure is applied to the grasping portions 20b of the opening part 20 along which the elastic fiber is disposed, the front surface 12 and the back surface 12 disposed on the opening part 20 are expanded in the direction of the arrow ↑.

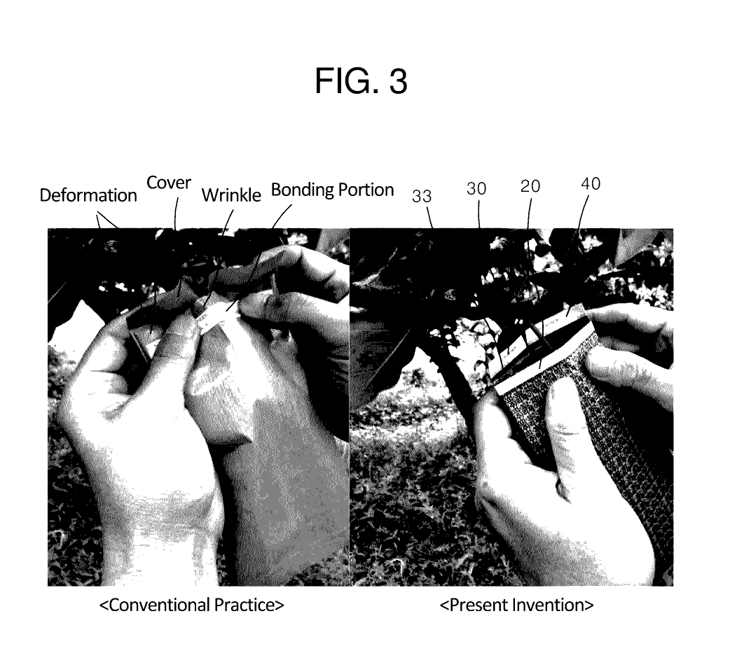

The fruit bag 100 according to the first embodiment of the present invention is provided with the opening part 20 capable of expanding the entrance a thereof, and accordingly, the fruit bag 100 has the following effects (See FIG. 3). Firstly, if young fruit is inserted into the conventional fruit bag, the front surface and the back surface thereof are deformed and wrinkled. This fails to quickly and accurately bond the cover to the bonding portion. In this case, contrarily, the front surface 11 and the back surface 12 of the fruit bag 100 do not have any deformation and wrinkles. As a result, the cover 30 can be accurately and quickly bonded by means of the bonding portions 40. Secondly, the conventional fruit bag has the deformation and wrinkles formed thereon, thereby making it hard to fold the cover along the folding line, and accordingly, the cover cannot be precisely and flattedly folded. Contrarily, the folding line 33 of the cover 30 of the fruit bag 100 is clearly defined by means of the opening part 20, so that the cover 30 can be precisely and rapidly folded.

Lastly, the fruit bag 100 according to the first embodiment of the present invention is configured to add only the opening part 20 to the original configuration thereof, so that it is simple in configuration, thereby providing an economical advantage. Further, the space of the opening part 20 is utilized together with the multiple folding portions 16, thereby sufficiently ensuring the space in which the young fruit grows. The opening part 20 takes a shape of a band and is made of a synthetic resin or natural resin, so that it is light in weight, without any danger falling down with the fruit. Furthermore, the opening part is made of the synthetic resin or natural resin having the shape of a sheet, so that when young fruit is inserted or grows, it may be not damaged at all. As the entrance of the fruit bag 100 is closed, thereby preventing rainwater or foreign matters from entering the fruit bag 100. Moreover, the opening part 20 is biodegradable, and accordingly, it may be easily collected and eco-friendly.

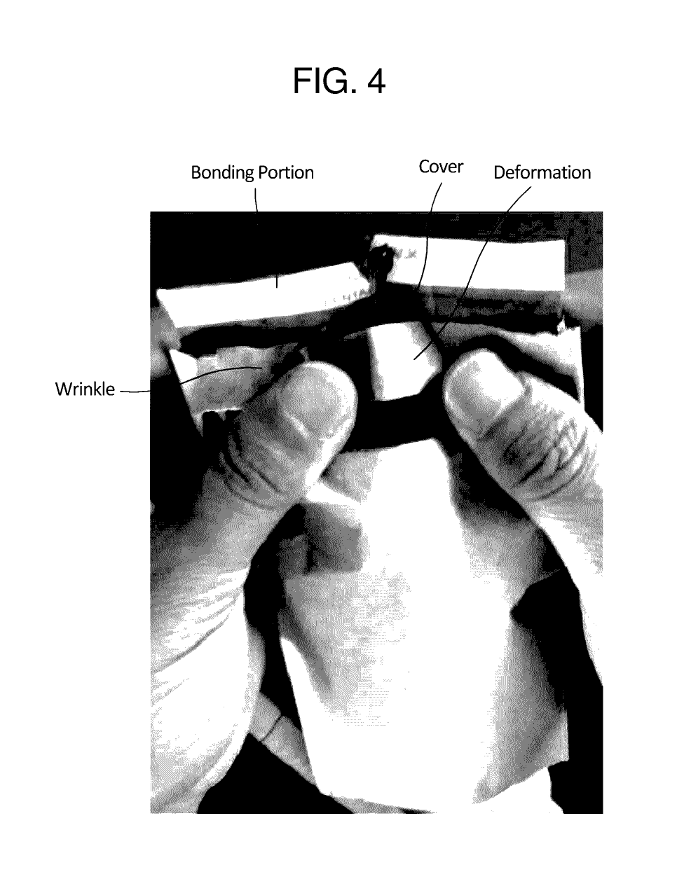

According to the first embodiment of the present invention, the opening part 20 is attached to the form of the band to the end portion of the body 10 forming the entrance a of the fruit bag 100. In this case, the end portion means the end of the front surface 11, and one side of the opening part 20 corresponds to the end of the front surface 11 forming the entrance a. If the opening part 20 is attached in the state of being spaced apart from the entrance a by a given distance, it is impossible to gently insert the young fruit into the entrance a when the entrance a is open because the front surface 11 and the back surface 12 located between the opening part 20 and the entrance a are made of soft materials. In more detail, if the young fruit is inserted into the entrance a, the portion around the entrance a becomes wrinkled and deformed, thereby making it difficult to bond the cover 30 well (See FIG. 4). Particularly, if a packing operation is conducted after the young fruit substantially grows because of the delay of the time for packing the young fruit, the wrinkles and deformation may occur more seriously.

Further, if the opening part 20 is attached in the state of being spaced apart from the entrance a by a given distance, the expansion of the multiple folding portions 16 is interrupted by means of the opening part 20 while the young fruit is growing. As a result, the young fruit does not grow well. According to the present invention, that is, the multiple folding portions 16, which are disposed on the opening part 20, serve as the hinges 22 together with the grasping portions 20b, and the opening part 20 is attached to the end portion of the entrance a. Accordingly, the multiple folding portions 16 are essential components of the fruit bag 100.

Furthermore, if the opening part 20 is attached in the state of being spaced apart from the entrance a by a given distance, folding the folding line 33 through the opening part 20 cannot be achieved. If folding the folding line 33 is not clearly carried out, the cover 30 cannot be precisely and rapidly folded. If the folding the folding line 33 is not clearly carried out, while the young fruit is being packed with the fruit bag 100, the packing operation becomes slow, and also, many failures occur. Furthermore, if numerous pieces of fruit are packed with the fruit bags, the above-mentioned problems become more serious, and also, the productivity of the packing operation is substantially decreased.

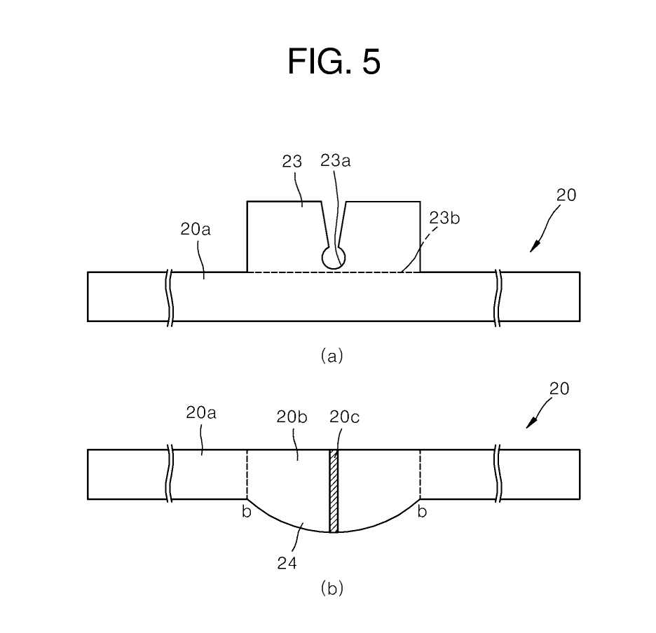

FIG. 5 is front views showing variations of the opening part 20 of the fruit bag 100 according to the first embodiment of the present invention. In this case, representative variations of the opening part 20 are illustrated, and of course, other variations of the opening part 20 may be adopted in the fruit bag 100 within the sprit and scope of the present invention. At this time, the fruit bag 100 will be explained with reference to FIGS. 1 and 2.

As shown in (a) of FIG. 5, the opening part 20 is provided to reinforce the stem insertion hole 32a. That is, a portion of the flat portion 20a is extended to reinforce the surrounding portion of the stem insertion hole 32a. The extended size is determined appropriately in accordance with the size of the fruit bag 100. In more detail, the opening part 20 as shown in (a) of FIG. 5 includes an extension portion 23, a hole 23a formed to allow the stem insertion hole 32a to be located therein, and a ruled line 23b formed for easy bending if necessary. The hole 23a is formed in such a manner as to locate the stem insertion hole 32a at the inside thereof. As the surrounding portion of the stem insertion hole 32a is reinforced with the extension portion 23, the stem insertion hole 32a can be protected from the damages caused by external forces. Further, the ruled line 23b corresponds to the folding line 33 so as to allow the cover 30 to be precisely folded.

As shown in (b) FIG. 5, the opening part 20 has an expansion portion 24 extended from the grasping portion 20b. As the grasping portion 20b is extended, the ruled line 20c becomes long. If a pressure is applied to the grasping portion 20b, the expansion portion 24 serves to prevent each side surface 13 of the fruit bag 100 from being distorted. In this case, the distortion means each side surface 13 may be irregularly bent. If the side surfaces 13 of the fruit bag 100 are distorted, it is hard to insert young fruit into the entrance a. On the other hand, the opening part 20 may have other various extension portions, even though not shown, within the technical scope of the present invention. For example, the opening part 20 as shown in (a) of FIG. 5 and the opening part as shown in (b) of FIG. 5 may be combined with each other.

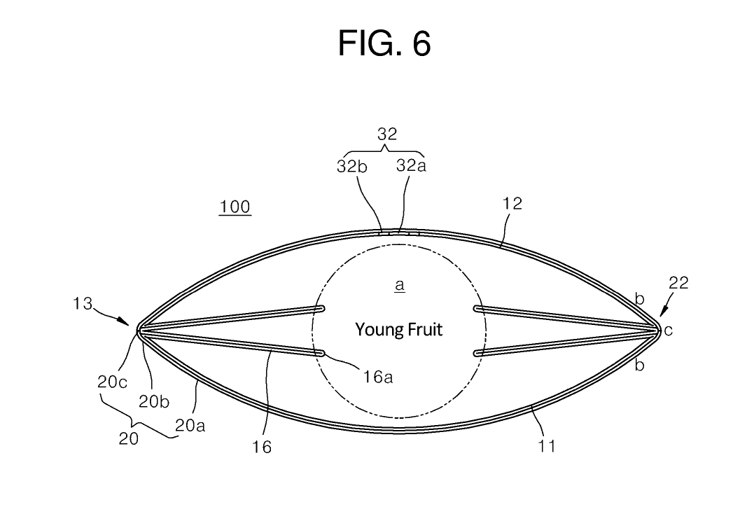

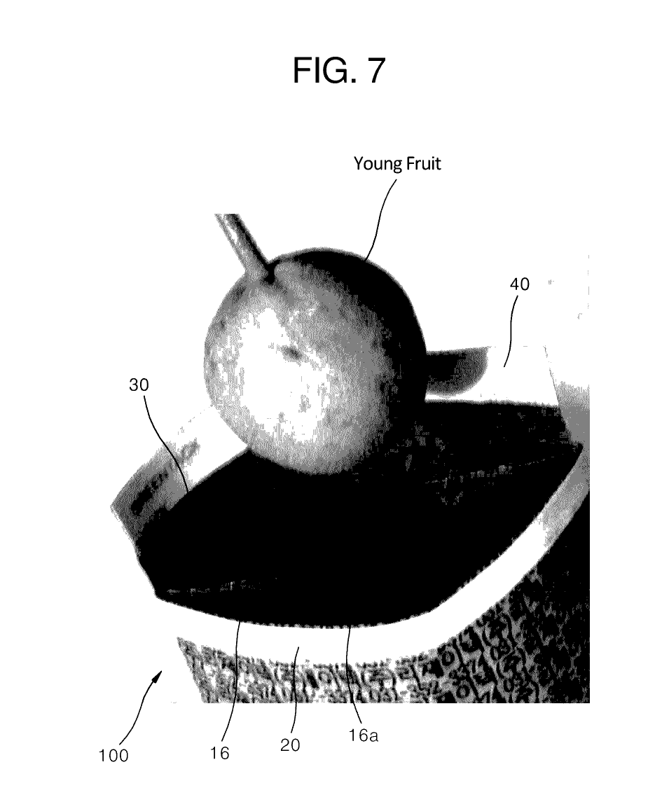

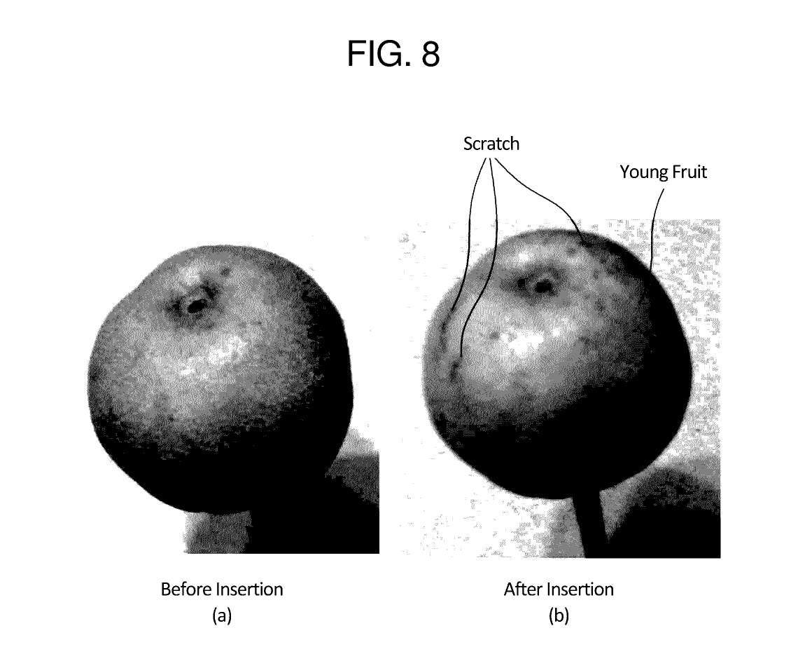

FIG. 6 is a plan view showing the fruit bag 100 according to the first embodiment of the present invention viewed from the entrance a thereof so as to explain the process for inserting the young fruit into the fruit bag 100. At this time, young fruit is indicated by a dotted line. FIG. 7 is a photograph showing the process for inserting the young fruit into the fruit bag 100 of FIG. 6, and FIG. 8 are photographs showing the scratches occurring on the young fruit before and after the young fruit is inserted into the fruit bag 100 according to the first embodiment of the present invention.

As shown in FIGS. 6 to 8, if a pressure is applied to the side surfaces 13 of the fruit bag 100 having the opening part 20 mounted thereon, the entrance a becomes expanded. In the state where the entrance a becomes expanded, young fruit is inserted into the fruit bag 100. At this time, the multiple folding portions 16 have the end portions 16a and are extended from the side surfaces 13. The end portions 16a are the folded portions of the multiple folding portions 16a. If young fruit is inserted into the fruit bag 100, the multiple folding portions 16a having the end portions 16a are pushed to both sides of the fruit bag 100 and then moved to the inner surfaces of the fruit bag 100 (See FIG. 7). Even if the entrance a is expanded, the front surface 11 around the entrance a is maintained flattedly by means of the opening part 20. That is, the front surface 11 is not wrinkled or deformed and is expanded to the expanded shape of the opening part 20.

If the cover 30 to which the bonding portions 40 are attached is folded to cover the entrance a, the young fruit is packed. The bond portions 40 are covered with release paper, when viewed from the photograph. If the release paper is removed, the bonding portions 40 are exposed to the outside. In more detail, the release paper is removed before the entrance a of the fruit bag 100 is covered with the cover 30. In this case, the bonding portions 40 are covered with the release paper, but as mentioned above, each bonding portion 40 is any one selected from an adhesive material, an adhesive tape protected by release paper and having an adhesive material applied thereto, a microcapsule having an adhesive material embedded therein, and a pocket film in which an adhesive material is put. In some cases, the bonding portions 40 may be formed on the front surface 11. Even if the entrance a is expanded, the front surface 11 is flattedly maintained, and accordingly, the cover 30 can be gently attached fixedly by means of the bonding portions 40.

By the way, as shown in FIG. 8, the end portions 16a may give damages to the surface of young fruit in accordance with the materials of the multiple folding portions 16, the kinds of young fruit, and the growing states of young fruit. The end portions 16a are in the folded state, so that they may be sharp. The sharpness of the end portions 16a causes scratches on the surface of young fruit. Due to the formation of the scratches, marks are left on the surface of young fruit. The marks lower the quality of young fruit. Hereinafter, an explanation on the structure of the multiple folding portions in which no marks are formed on the surface of young fruit will be in detail given.

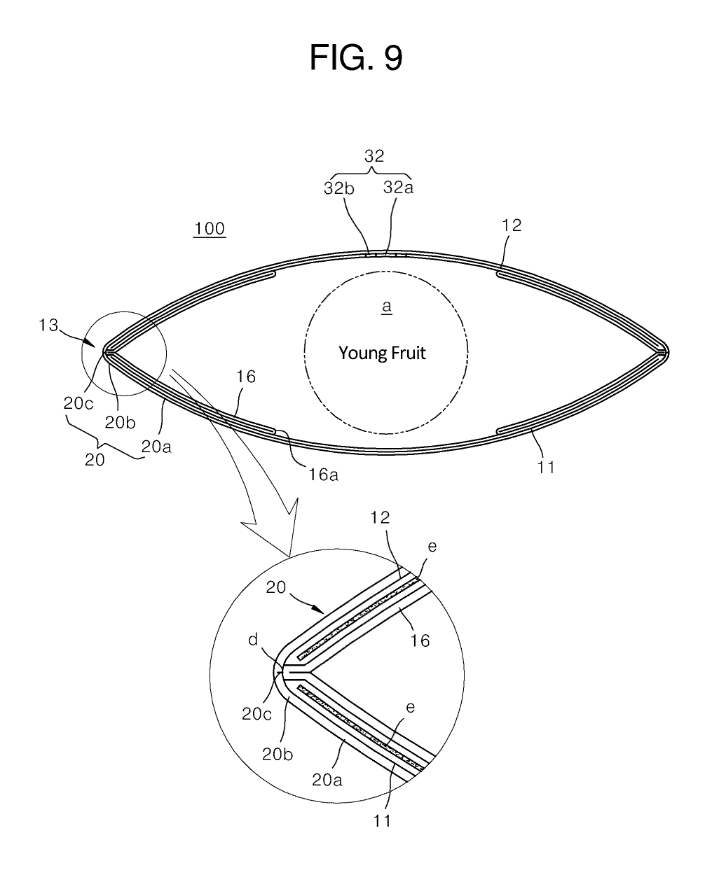

FIGS. 9 to 11 are plan views showing various examples of the multiple folding portions 16 adopted in the fruit bag 100 according to the first embodiment of the present invention. At this time, each multiple folding portion 16 is divided into a first bonding portion d coming into contact with each side surface 13, a second bonding portion e bonded to the front surface 11 or the back surface 12, and a third bonding portion f to which the multiple folding portion 16 is bonded. For the brevity of the description, also, the illustration of the bonding portions 40 is avoided.

As shown in FIGS. 9 to 11, the multiple folding portions 16 are configured wherein the first bonding portion d is not bonded to each side surface 13 and the second bonding portions e are bonded to the front surface 11 and the back surface 12 (See FIG. 9). That is, one side multiple folding portion 16 is attached to the front surface 11 and the other side thereof to the back surface 12. When the young fruit is inserted into the fruit bag 100, in this case, the occurrence of marks on the surface of young fruit by means of the existence of the end portions 16a can be prevented. As the second bonding portions e are moved to the front surface 11 and the back surface 12, the space of the entrance a becomes enlarged. When the young fruit is inserted into the fruit bag 100, accordingly, the contact of young fruit with the end portions 16a can be prevented, thereby causing no marks on the surface of young fruit.

On the other hand, the bonding depth of the multiple folding portions 16, that is, the bonding portion of the multiple folding portions 16 from the end portion of the front surface 11 is desirably in the range of about 2 to 5 mm. If the bonding depth is too large, the multiple folding portions 16 providing the space in which young fruit grows cannot be expanded appropriately. Accordingly, the bonding depth is determined appropriately in consideration of the bonding effects of the multiple folding portions 16 and the formation of the space. For example, if the bonding depth is smaller than 2 mm, the multiple folding portions 16 do not bond well, and contrarily, if the bonding depth is larger than 5 mm, the expanded portion of the multiple folding portions 16 becomes reduced.

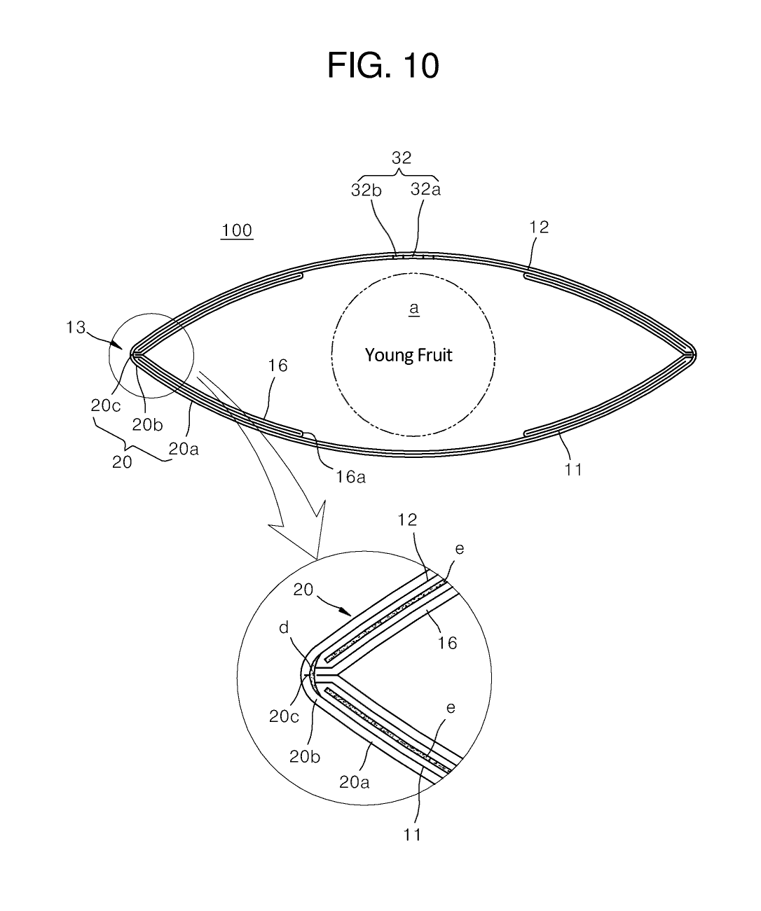

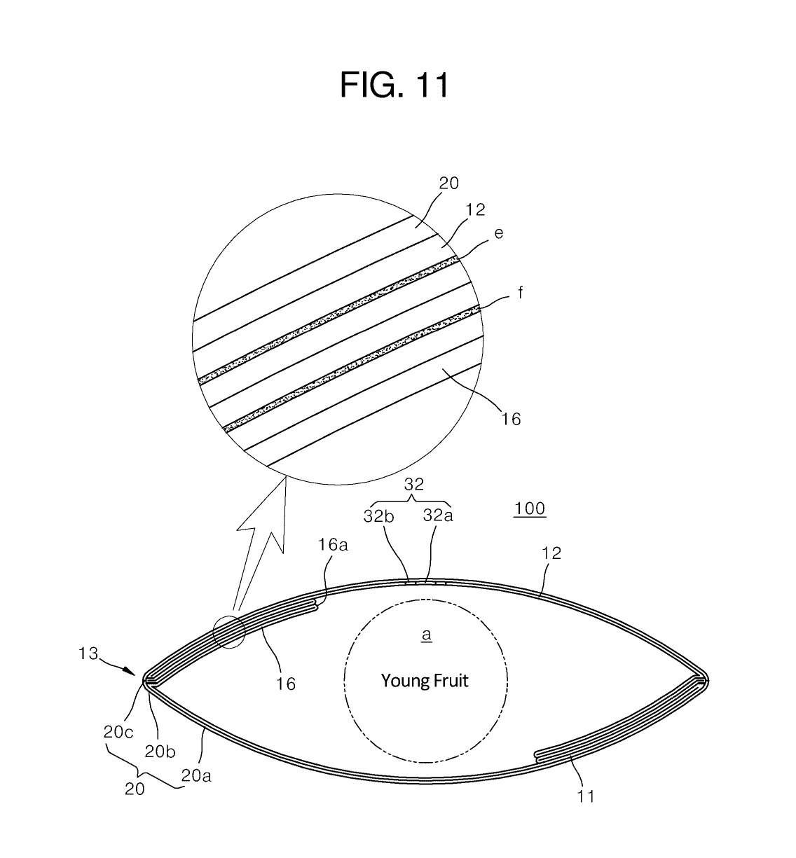

According to another example of the multiple folding portions 16, the first bonding portion d is bonded to the side surface 13 and the second bonding portions e are bonded to the front surface 11 and the back surface 12 (See FIG. 10). That is, the multiple folding portions 16 are the same as the above-mentioned multiple folding portions 16 except that the first folding portion d is bonded to the side surface 13. As the second bonding portions e are moved to the front surface 11 and the back surface 12, the space of the entrance a becomes enlarged. When the young fruit is inserted into the fruit bag 100, accordingly, the contact of young fruit with the end portions 16a can be prevented, thereby causing no marks on the surface of young fruit. According to yet another example of the multiple folding portions 16, the first bonding portion d is bonded to the side surface 13 and the second bonding portions e are crossedly bonded to the front surface 11 and the back surface 12 (See FIG. 11). That is, the second bonding portions e are located on the side surfaces 13 in such a manner as to face each other. At this time, the third bonding portion f bonds the multiple folding portions 16 to each other. As the second bonding portions e are crossedly located on the front surface 11 and the back surface 12, the space of the entrance a becomes enlarged. When the young fruit is inserted into the fruit bag 100, accordingly, the contact of young fruit with the end portions 16a can be prevented, thereby causing no marks on the surface of young fruit.

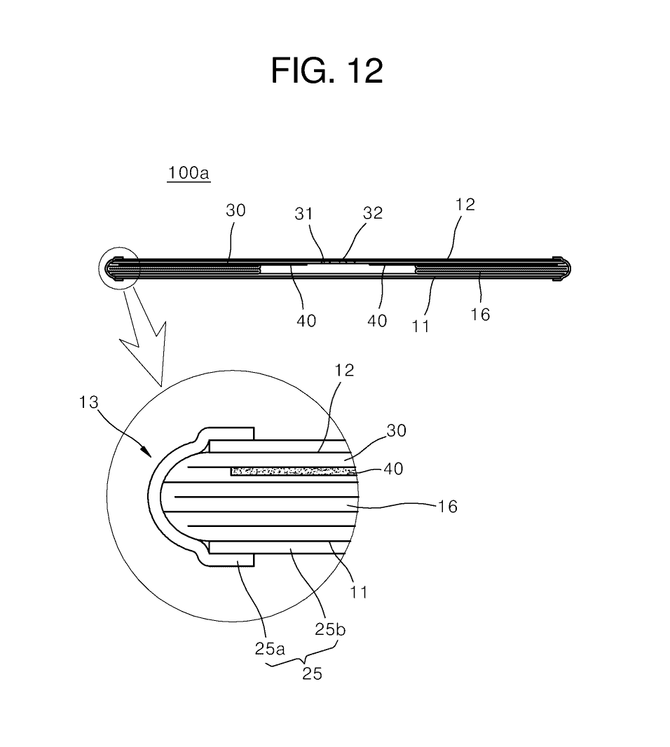

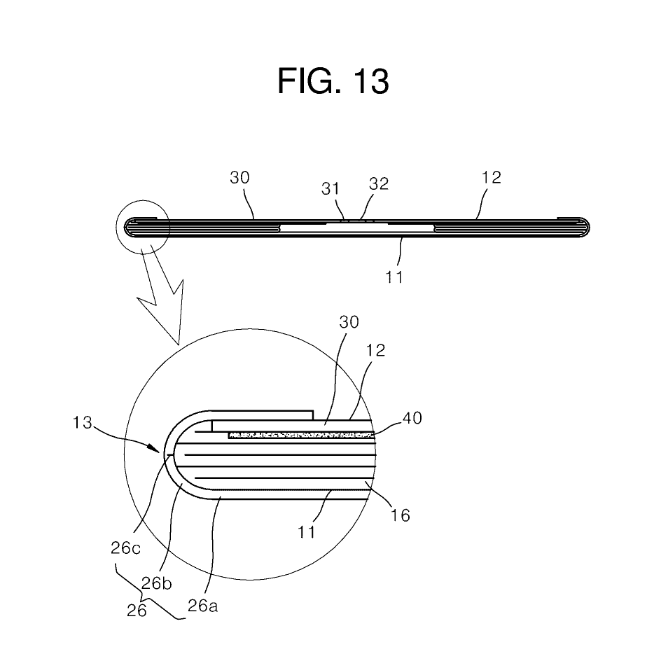

FIGS. 12 and 13 are plan views showing variations of the fruit bag 100 according to the first embodiment of the present invention. At this time, a fruit bag 100a according to a first variation of the fruit bag 100 and a fruit bag 100b according to a second variation of the fruit bag 100 are the same as the fruit bag 100 according to the first embodiment of the present invention except that opening parts are different from that of the fruit bag 100.

As shown in FIG. 12, an opening part 25 of the fruit bag 100a according to the first variation of the fruit bag 100 includes flat portions 25a bonded to the front surface 11 and the back surface 12 and grasping portions 25b formed on the side surfaces 13, and the flat portions 25a and the grasping portions 25b are combined to each other in the form of pieces. In more detail, each grasping portion 25b is laid on the flat portions 25a attached previously to the front surface 11 and the back surface 12. The pieces of grasping portions 25b have different stiffness from the flat portions 25a. That is, the grasping portions 25b are made of different materials from the materials of the flat portions 25a, and otherwise, they have different thickness and width from the flat portions 25a. According to the first variation of the fruit bag 100, the grasping portions 25b are designed in more various shapes than those in FIGS. 1 and 2. Furthermore, no ruled lines 20c are formed on the grasping portions 25b, and accordingly, there is no need for forming the ruled lines 20c, thereby providing the advantages in the manufacturing process.

On the other hand, for example, the end portions of each grasping portion 25b are laid on the flat portions 25a, and in some cases, they can be attached to the front surface 11 and the back surface 12. That is, the end portions of each grasping portion 25b and the flat portions 25a are attached to the front surface 11 and the back surface 12. At this time, the end portions of each grasping portion 25b may come into contact with the flat portions 25a, and otherwise, they may be spaced apart from the flat portions 25a by a given distance.

As shown in FIG. 13, an opening part 26 of the fruit bag 100b according to the second variation of the fruit bag 100 is configured wherein a flat portion 26a connected to one end of each grasping portion 26b is bonded to only a portion of the back surface 12. That is, the flat portion 26a is not formed over the entire portion of the back surface 12, and a portion of the flat portion 26a is extended from each side surface 13 by a given distance. At this time, the opening part 26 has a ruled line 26c. If the fruit bag 100b is covered with the cover 30, the flat portion 26a of the back surface 12 is exposed to the outside of the fruit bag 100b, that is, to external environments, so that as time goes by, the exposed portion is deformed, and therefore, the material is unnecessarily consumed. Accordingly, the fruit bag 100b according to the second variation of the fruit bag 100 is configured to remove the unnecessarily consumed component therefrom. The length g of the portion extended from the end portion of each side surface 13 is adjusted to the degree capable of sufficiently obtaining the effects of the fruit bag according to the present invention. That is, no wrinkles and deformation are formed on the cover 30, while the folding line 33 is being sufficiently utilized.

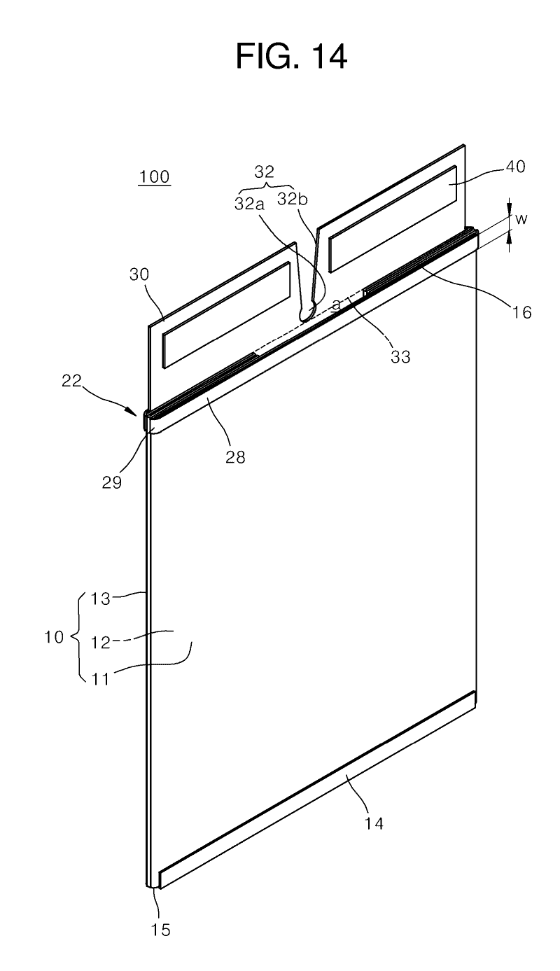

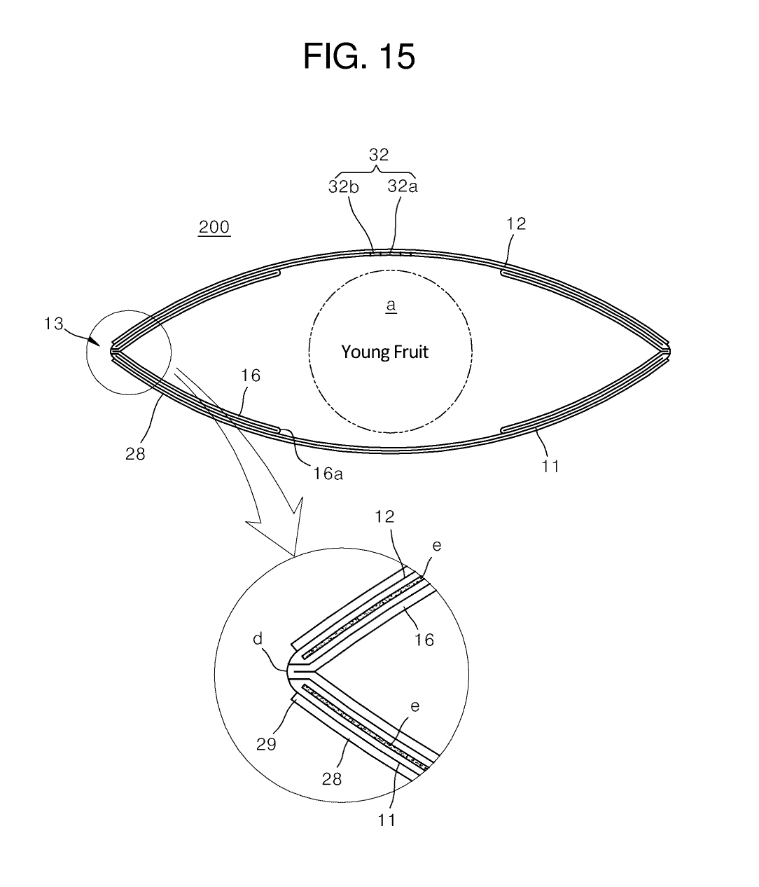

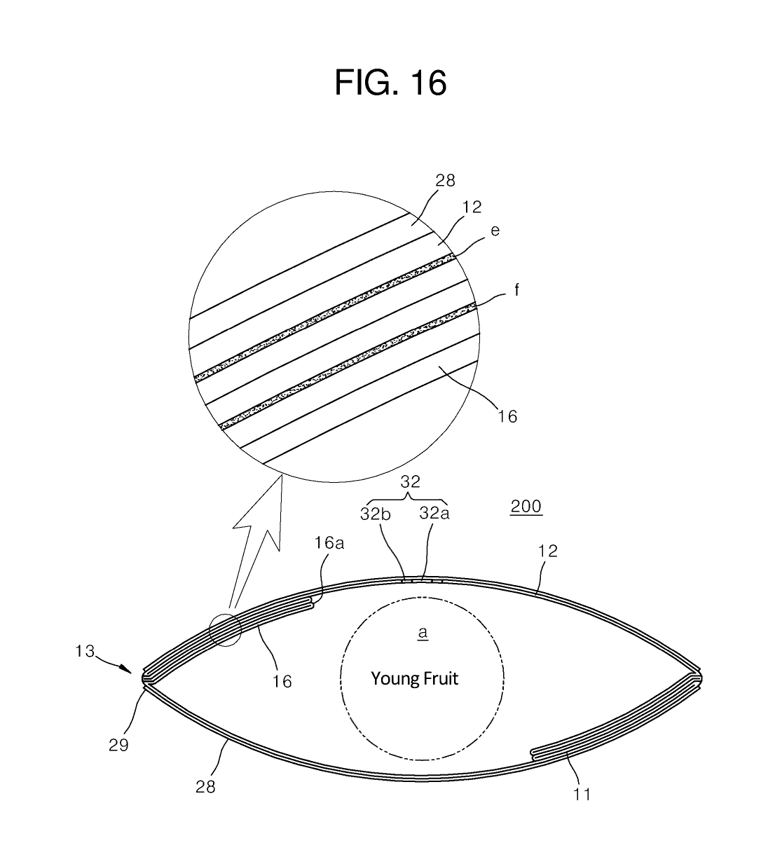

FIG. 14 is a perspective view showing a fruit bag 200 according to a second embodiment of the present invention, and FIGS. 15 and 16 are plan views showing examples of multiple folding portions 16 of the fruit bag 200 according to the second embodiment of the present invention. The fruit bag 200 is the same as the fruit bag 100 except that the structure of an opening part 28 and the examples of the multiple folding portions are different from those of the fruit bag 100. Accordingly, an explanation on the repeated portions with those of the fruit bag 100 will be avoided for the brevity of description.

As shown in FIGS. 14 to 16, the fruit bag 200 has the opening part 28 spaced apart from the side surfaces 13 and bonded to the front surface 11 and the back surface 12. The opening part 28 has the same functions and roles as the flat portions 20a of the fruit bag 100. The portions of the opening part 28 coming into contact with the side surfaces 13 form grasping portions 29. As mentioned above, the grasping portions 29 are the portions to which a pressure is applied by a user, so that they expand the opening part 28 to allow the entrance a to be enlarged. The opening part 28 has the material, shape and physical properties as suggested in the fruit bag 100.

The fruit bag 200 having the opening part 28 has multiple folding portions 16, wherein the multiple folding portions 16 have second folding portions e as shown in FIG. 15, and otherwise, they have second folding portions e and third bonding portions f as shown in FIG. 16. That is, the multiple folding portions 16 are bonded to the front surface 11 and the back surface 12 in such a manner as to face each other by means of the second bonding portions e. At this time, the multiple folding portions 16 are crossedly bonded to the front surface 11 and the back surface 12 by means of the third bonding portions f. Like this, the multiple folding portions 16 bonded to the front surface 11 and the back surface 12 serve as the hinges 22 of the fruit bag 100 as mentioned above. Accordingly, if a pressure is applied to the grasping portions 29 by a user, the opening part 28 is expanded to allow the entrance a to be enlarged.

If the multiple folding portions 16 are not bonded to the front surface 11 and the back surface 12, they move, without being fixed, when the pressure is applied by means of the grasping portions 29, thereby making it hard to constantly maintain the shape of the entrance a. If the multiple folding portions 16 are bonded to the front surface 11 and the back surface 12, they do not move even though the pressure is applied, thereby constantly maintaining the shape of the entrance a and preventing young fruit from being damaged. The multiple folding portions 16 have a bonding depth in the range of 2 to 5 mm, as explained with reference to FIGS. 11 and 13.

The fruit bag 200 according to the second embodiment of the present invention is provided with the opening part 28 capable of expanding the entrance a thereof, and accordingly, the fruit bag 100 has the following effects (See FIG. 14). Firstly, if young fruit is inserted into the conventional fruit bag, the front surface and the back surface thereof are deformed and wrinkled. This fails to quickly and accurately bond the cover to the bonding portion. In this case, contrarily, the front surface 11 and the back surface 12 of the fruit bag 200 do not have any deformation and wrinkles. As a result, the cover 30 can be accurately and quickly bonded to the body 10 by means of the bonding portions 40. Secondly, the conventional fruit bag has the deformation and wrinkles formed thereon, thereby making it hard to fold the cover along the folding line, and accordingly, the cover cannot be precisely and flattedly folded. Contrarily, the folding line 33 of the cover 30 of the fruit bag 200 is clearly defined by means of the opening part 28, so that the cover 30 can be precisely and rapidly folded.

Lastly, the fruit bag 200 according to the second embodiment of the present invention is configured to add only the opening part 28 to the original configuration thereof, so that it is simple in configuration, thereby providing an economical advantage. Further, the space of the opening part 28 is utilized together with the multiple folding portions 16, thereby sufficiently ensuring the space in which the young fruit grows. The opening part 28 takes a shape of a band and is made of a synthetic resin or natural resin, so that it is light in weight, without any danger falling down with the fruit. Furthermore, the opening part 28 is made of the synthetic resin or natural resin having the shape of a sheet, so that when young fruit is inserted or grows, it may be not damaged at all. As the entrance of the fruit bag 200 is closed, thereby preventing rainwater or foreign matters from entering the fruit bag 200. Moreover, the opening part 28 is biodegradable, and accordingly, it may be easily collected and eco-friendly.

According to the second embodiment of the present invention, the opening part 28 is attached to the form of the band to the end portion of the body 10 forming the entrance a of the fruit bag 200. In this case, the end portion means the end of the front surface 11, and one side of the opening part 28 corresponds to the end of the front surface 11 forming the entrance a. If the opening part 28 is attached in the state of being spaced apart from the entrance a by a given distance, it is impossible to gently insert the young fruit into the entrance a when the entrance a is open because the front surface 11 and the back surface 12 located between the opening part 28 and the entrance a are made of soft materials. In more detail, if the young fruit is inserted into the entrance a, the portion around the entrance a becomes wrinkled and deformed, thereby making it difficult to bond the cover 30 (See FIG. 4). Particularly, if a packing operation is conducted after the young fruit substantially grows because of the delay of the time for packing the young fruit, the wrinkles and deformation may occur more seriously.

Further, if the opening part 28 is attached in the state of being spaced apart from the entrance a by a given distance, the expansion of the multiple folding portions 16 is interrupted by means of the opening part 28 while the young fruit is growing. As a result, the young fruit does not grow well. According to the present invention, that is, the multiple folding portions 16, which are disposed on the opening part 28, serve as the hinges 22 (as shown in FIG. 1), and the opening part 28 is attached to the end portion of the entrance a. Accordingly, the multiple folding portions 16 are essential components of the fruit bag 200.

Furthermore, if the opening part 28 is attached in the state of being spaced apart from the entrance a by a given distance, folding the folding line 33 through the opening part 28 cannot be achieved. If folding the folding line 33 is not clearly carried out, the cover 30 cannot be precisely and rapidly folded. If the folding the folding line 33 is not clearly carried out while the young fruit is being packed with the fruit bag 100, the packing operation becomes slow, and, also many failures occur. Furthermore, if numerous pieces of fruit are packed with the fruit bags, the above-mentioned problems become more serious, and also, the productivity of the packing operation is substantially decreased.

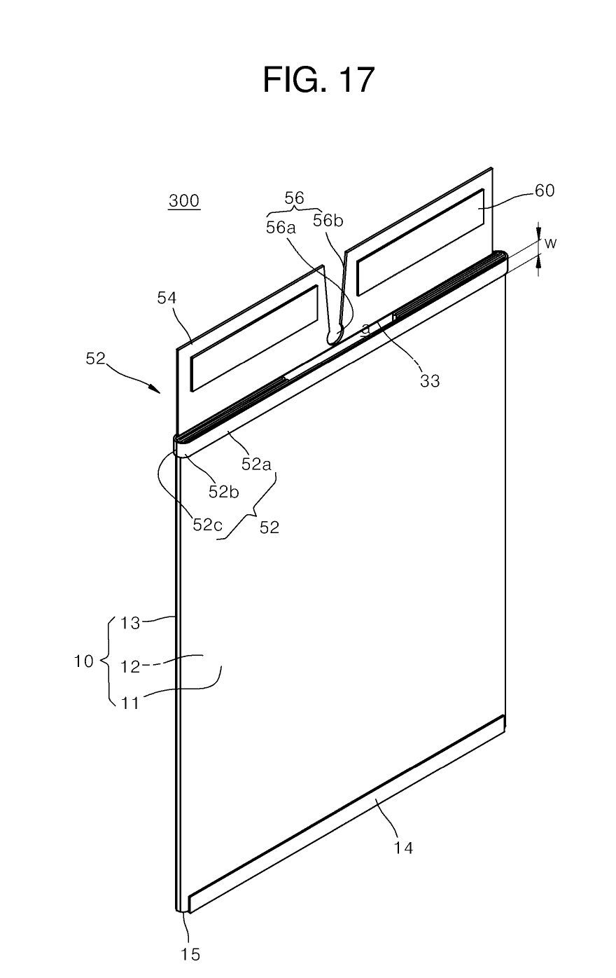

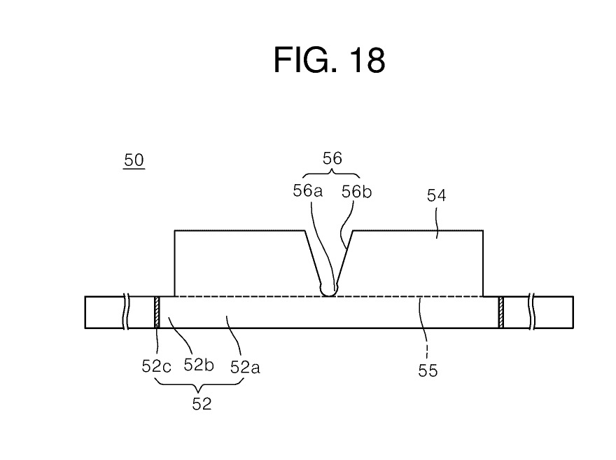

FIG. 17 is a perspective view showing a fruit bag 300 according to a third embodiment of the present invention. FIG. 18 is a front view showing an opening structure 50 of the fruit bag 300 of FIG. 17. The fruit bag 300 is the same as the fruit bag 100 and the fruit bag 200 except that the opening structure 50 is provided separately therefrom. For the brevity of description, a detailed explanation on the same reference numerals as the fruit bag 100 will be avoided.

As shown in FIGS. 17 and 18, the opening structure 50 is made separately from the fruit bag 300 and attached to the body 10 of the fruit bag 300. The opening parts 20 and 28 of the fruit bag 100 and the fruit bag 200 have the same functions and roles as an opening part 52 of the fruit bag 300, and the flat portions 20a, the grasping portions 20b and the ruled lines 20c of the opening part 20 correspond to flat portions 52a, grasping portions 52b and ruled lines 52c of the opening part 52. The cover 30 and the stem insertion portion 32 correspond to a cover 54 and a stem insertion portion 56, and the stem insertion hole 32a and the cut portion 32b have the same functions and roles as a stem insertion hole 56a and a cut portion 56b. Further, the fruit bag 300 includes a folding line 55 and bonding portions 60 corresponding to the folding line 33 and the bonding portions 40 of the fruit bag 100.

The material and stiffness of the opening structure 50 are the same as the opening parts 20 and 28 of the fruit bag 100 and the fruit bag 200 as mentioned above. That is, if a pressure is applied to the side surfaces 13, the entrance a is expanded by means of the opening part 52. Further, the opening structure 50 has its own stiffness, as mentioned above, so that it can basically prevent the front surface 11 and the cover 54 from being deformed and wrinkled. Through the folding line 55 of the opening structure 50, the cover 54 can be folded accurately and rapidly. Furthermore, the fruit bag 300 still has the advantages of the fruit bag 100 and the fruit bag 200.

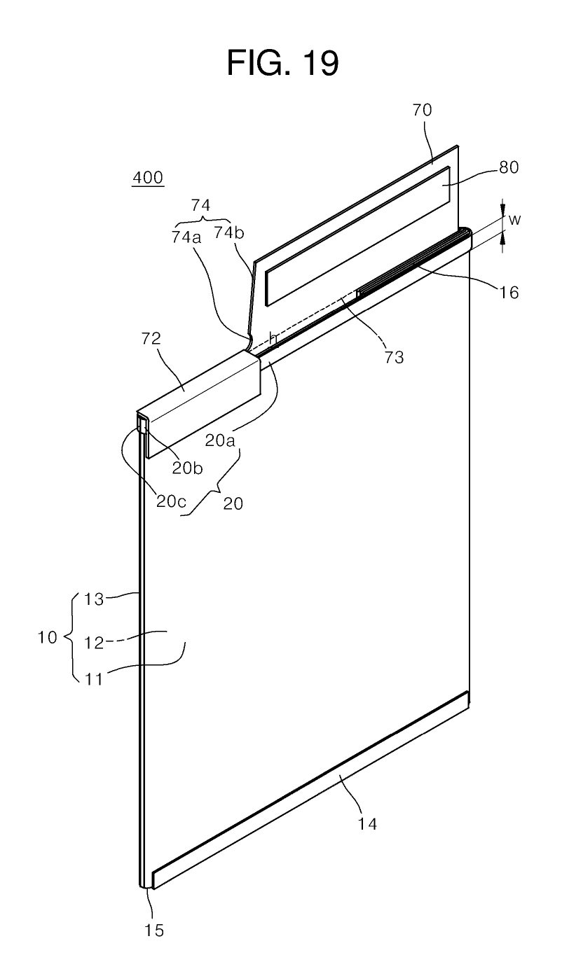

FIG. 19 is a perspective view showing a fruit bag 400 according to a fourth embodiment of the present invention. The fruit bag 400 is the same as the fruit bag 100 and the fruit bag 200 except that a sealing portion 72 is provided to cover a portion of an entrance h. For the brevity of description, a detailed explanation on the same reference numerals as the fruit bag 100 will be avoided.

As shown in FIG. 19, the fruit bag 400 has the opening part 20 or 28 of the fruit bag 100 or the fruit bag 200. However, the extended portion from the back surface 12 is divided into both side portions, that is, the cover 70 and the sealing portion 72, around a stem insertion portion 74. The sealing portion 72 is fixedly attached to the opening part 20 and the front surface 11. Accordingly, the entrance h becomes smaller than the entrance a of the fruit bag 100 or the fruit bag 200. The stem insertion portion 74 is formed on one end of the cover 70 and includes a stem insertion hole 74a and a cut portion 74b. Further, the fruit bag 400 has a folding line 55, which has been in detail explained through the folding line 33 of the fruit bag 100 or the fruit bag 200. A bonding portion 80 is attached to the cover 70 for closing the fruit bag 400.

The material and stiffness of the opening part 20 of the fruit bag 400 are the same as the opening parts 20 and 28 of the fruit bag 100 and the fruit bag 200 as mentioned above. That is, if a pressure is applied to the side surfaces 13, the entrance h is expanded by means of the opening part 20. Through the formation of the folding line 73, the cover 70 can be precisely and rapidly folded. The bonded portion of the fruit bag 400 is more reduced than that of the fruit bag 100 or the fruit bag 200. In case of the fruit bag 100 or the fruit bag 200, that is, both sides of the stem insertion portion 32 should be bonded, but in case of the fruit bag 400, only one side of the stem insertion portion 74 should be bonded. Accordingly, the packing operation with the fruit bag 400 is simpler than that with the fruit bag 100 or the fruit bag 200. Furthermore, the fruit bag 400 still has the advantages of the fruit bag 100 and the fruit bag 200.

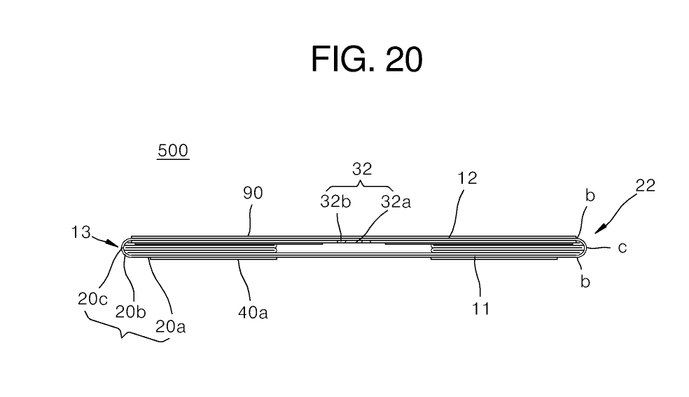

FIG. 20 is a plan view showing a fruit bag 500 according to a fifth embodiment of the present invention. The fruit bag 500 is the same as the fruit bags 100 to 400 except that bonding portions 40a are formed on the opening part 20 disposed on the front surface 11 and a release layer 90 is formed on the opening part 20 disposed on the back surface 12. The fruit bag 500 will be explained with reference to, for example, to the fruit bag 100, but of course, it may be explained with reference to the fruit bags 200 to 400.

As shown in FIG. 20, the fruit bag 500 has the bonding portions 40a formed on the flat portion 20a of the opening part 20 disposed on the front surface 11 (hereinafter, referred to as the front surface flat portion 20a of the opening part 20) and the release layer 90 formed on the flat portion 20a of the opening part 20 disposed on the back surface 12 (hereinafter, referred to as the back surface flat portion 20a of the opening part 20). The materials of the bonding portions 40a are the same as mentioned above. The release layer 90 serves to cover the entire portion or a portion of the back surface flat portion 20a of the opening part 20. Desirably, the release layer 90 is formed to a range capable of covering the bonding portions 40a when the fruit bags 500 are laid on each other. That is, when the fruit bags 500 are laid sequentially on each other in such a manner as to allow the bonding portions 40a to be aligned with each other, the release layers 90 are placed on the bonding portions 40a to prevent the fruit bags 500 from being attached to each other by means of the bonding portions 40a. Even if not shown, a release layer may be formed on a portion of the back surface 12 of the fruit bag 500, and otherwise, release layers are formed on portions of the back surface 12 and the cover 30 of the fruit bag 500. The release layer formed on the back surface 12 allows the opening part 20 to be located therein, and it may be extended from the opening part 20.

The release layer 90 is made of lubricant, wax, silicone resin, fluorocarbon resin, polyvinyl alcohol, paraffin, polytetrafluoroethylene PTFE dispersion, or the like, which is not bonded to the bonding portions 40a and is easily released from the bonding portions 40a. The release layer 90 is easily applicable. The release layer 90 is applied using inkjet printing, laser printing, digital printing, spraying, electrostatic spraying, offset lithography, flexography, gravure printing, roll printing, and the like. In some cases, the release layer 90 is bonded to the form of a synthetic resin film like PTFE to the back surface flat portion 20a of the opening part 20. In more detail, the synthetic resin film is bonded to the back surface flat portion 20a to form the release layer 90. Like this, the formation of the release layer 90 prevents the bonding portions 40a and the adjacent fruit bag 500 from being attached to each other.

When the fruit bags 500 are laminated on each other, the bonding force of the bonding portions 40a is shielded through the formation of the release layer 90, thereby finishing the lamination of the fruit bags 500, without any trouble. That is, the release layer 90 prevents the adjacent fruit bags 500 from being bonded to each other by means of the bonding portions 40a, while the fruit bags 500 are being laminated on each other. Accordingly, the fruit bags 500 can be laminated on each other and also kept for a long period of time. One of the laminated fruit bags 500 is separated by a user, and the fruit portion of the young fruit is accommodated in the separated fruit bag 500. After the accommodation, the cover 30 is folded and bonded to the front surface of the opening part 20. Unlike the conventional practice, in this case, no release paper is needed. If the release paper falls to the soil, it is not degraded. According to the fruit bag 500, as a result, the environmental pollution caused by the release paper can be prevented.

On the other hand, a glove coated with a release material like fluorocarbon resin is worn by the user so as to prevent the bonding portions 40a from being attached to his or her hand. Desirably, the release material is coated only on the thumb and index finger of the glove. The release material is copolymerized with the material of the glove, and otherwise, it is coated on the surface of the glove.

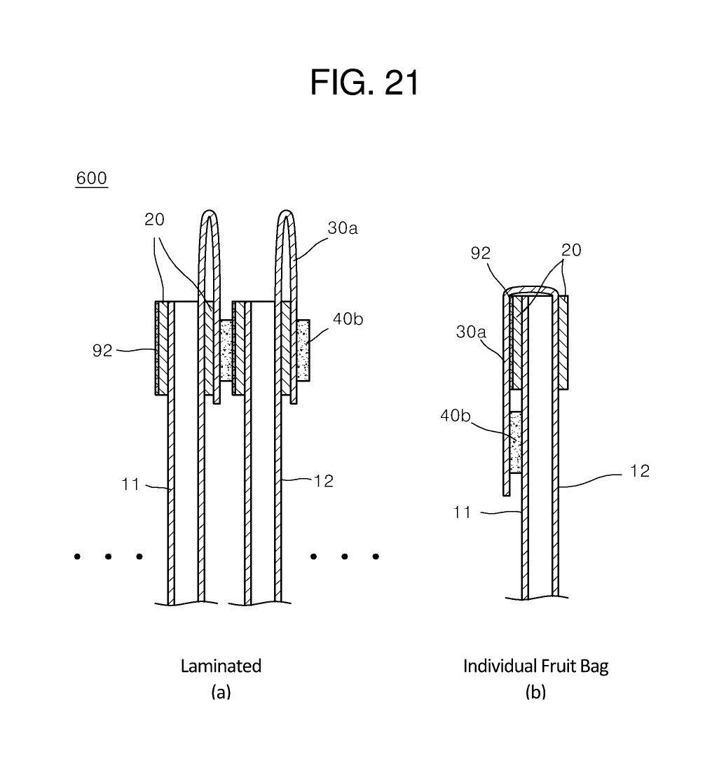

FIG. 21 is a sectional view showing a fruit bag 600 according to a sixth embodiment of the present invention. The fruit bag 600 is the same as the fruit bags 100 to 400 except that a release layer 92 is formed on the opening part 20 disposed on the front surface 11 and bonding portions 40a are formed on the cover 30a. The fruit bag 600 will be explained with reference to, for example, to the fruit bag 100, but of course, it may be explained with reference to the fruit bags 200 to 400. Further, the laminated fruit bags 600 and the individual fruit bag 600 are illustrated separately.

As shown in FIG. 21, the fruit bag 600 has the release layer 92 formed on the flat portion 20a of the opening part 20 disposed on the front surface 11 (hereinafter, referred to as the front surface flat portion 20a of the opening part 20) and bonding portions 40b formed on the cover 30a. At this time, the cover 30a is bent toward the back surface 12. The materials of the bonding portions 40b are the same as mentioned above. The release layer 92 serves to cover the entire portion or a portion of the front surface flat portion 20a of the opening part 20. Desirably, the release layer 92 is formed to a range capable of covering the bonding portions 40b when the fruit bags 600 are laid on each other. That is, when the fruit bags 600 are laid sequentially on each other in such a manner as to allow the bonding portions 40b to be aligned with each other, the release layers 92 are placed on the bonding portions 40b to prevent the fruit bags 600 from being attached to each other through the bonding portions 40b. As shown, it can be appreciated from the laminated fruit bags 600.

The release layer 92 is made of lubricant, wax, silicone resin, fluorocarbon resin, polyvinyl alcohol, paraffin, polytetrafluoroethylene PTFE dispersion, or the like, which is not bonded to the bonding portions 40b and is easily released from the bonding portions 40b. The release layer 92 is easily applicable. The release layer 92 is applied using inkjet printing, laser printing, digital printing, spraying, electrostatic spraying, offset lithography, flexography, gravure printing, roll printing, and the like. In some cases, the release layer 92 is bonded to the form of a synthetic resin film like PTFE to the front surface flat portion 20a of the opening part 20. In more detail, the synthetic resin film is bonded to the front surface flat portion 20a to form the release layer 92. Like this, the formation of the release layer 92 prevents the bonding portions 40b and the adjacent fruit bag 600 from being attached to each other.

When the fruit bags 600 are laminated on each other, the bonding force of the bonding portions 40b is shielded through the formation of the release layer 92, thereby finishing the lamination of the fruit bags 600, without any trouble. That is, the release layer 92 prevents the adjacent fruit bags 600 from being bonded to each other by means of the bonding portions 40b, while the fruit bags 600 are being laminated on each other. Accordingly, the fruit bags 600 can be laminated on each other and also kept for a long period of time.

One of the laminated fruit bags 600 is separated by a user, and the fruit portion of the young fruit is accommodated in the separated fruit bag 600. After the accommodation, the cover 30a is folded and bonded to the front surface of the opening part 20. In more detail, if the bent cover 30a is folded toward the front surface 11, the bonding portions 40b are passed over the flat portion 20a (See FIG. 1) of the front surface of the opening part 20 on which the release layer 92 is formed and then attached to the front surface 11 of the fruit bag 600. Accordingly, the cover 30a has a given size capable of allowing the front surface flat portion 20a to be located inside the boding portions 40b. Unlike the conventional practice, in this case, no release paper is needed. If the release paper falls to the soil, it is not degraded. According to the fruit bag 600, as a result, the environmental pollution caused by the release paper can be prevented.

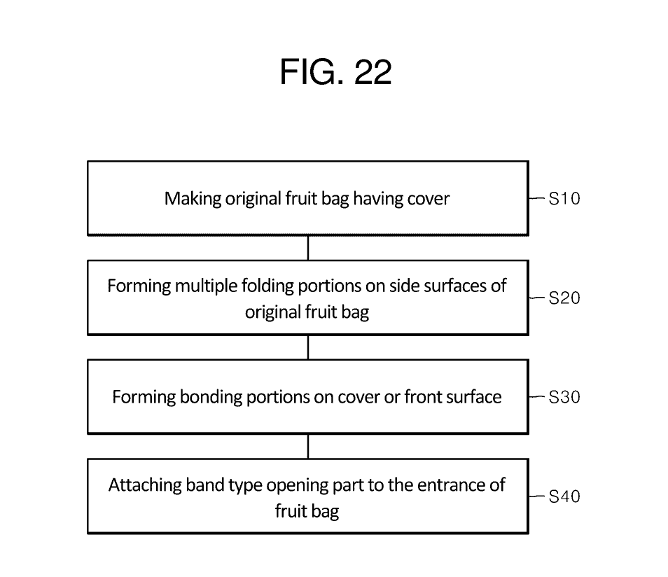

FIG. 22 is a flow chart showing the process for manufacturing the fruit bag according to the present invention.

As shown in FIG. 22, original fruit bags 100, 200 and 400 having the covers 30 and 70 are first made (Step S10). The original fruit bags are bags before the multiple folding portions 16 are formed, and they are made by the process for manufacturing general bags. In case of the fruit bag 300, the opening structure 50 is made instead of the opening part 20 and the cover 30. After that, the multiple folding portions 16 are formed on the side surfaces 13 of the original fruit bags (Step S20). The multiple folding portions 16 are the portions folded one or more times on the side surfaces 13. Next, the bonding portions 40, 60 and 80 are formed on the covers 30, 54, and 70 or the front surface 11 (Step S30). Each of the bonding portions 40, and 80 is any one selected from an adhesive material, an adhesive tape protected by release paper and having an adhesive material applied thereto, a microcapsule having an adhesive material embedded therein, and a pocket film in which an adhesive material is put. In this case, the adhesive material includes typically known adhesives.

After that, a band type opening part is attached to the entrance a (Step S40) of the fruit bag. In this case, the opening part includes the opening parts 20 as shown in FIGS. 1,4 and 18, the opening part 25 as shown in FIG. 11, the opening part 26 as shown in FIG. 12, the opening part 28 as shown in FIG. 13, and the opening part 52 as shown in FIG. 16. Each of the opening parts 20, 25, 26, 28 and 52 is formed by applying an adhesive to a given position of the fruit bag and by then attaching cut resin to the portion to which the adhesive is applied, and otherwise, the resin to which an adhesive is applied is cut to the shape of a tape and attached to the given position of the fruit bag. On the other hand, the fruit bag 400 fixedly bonds the sealing portion 72 to the opening part 20 and the front surface 11.

In case of the fruit bag 500, on the other hand, the step (S30) of forming the bonding portions is replaced with the step of forming the bonding portions 40a on the front surface flat portion of the opening part having the release layer 90 formed on the back surface flat portion. In case of the fruit bag 600, the bonding portions 40b are formed only on the cover 30a in the bonding portion forming step (S30), and the release layer 92 is formed on the front surface flat portion 20a of the opening part 20. Accordingly, desirably, the release layers 90 and 92 of the fruit bags 500 and 600 are previously formed on the back surface flat portion 20a and the front surface flat portion 20a of the opening part 20. Of course, the release layers 90 and 92 may be formed after the step (S40) of attaching the opening part 20.

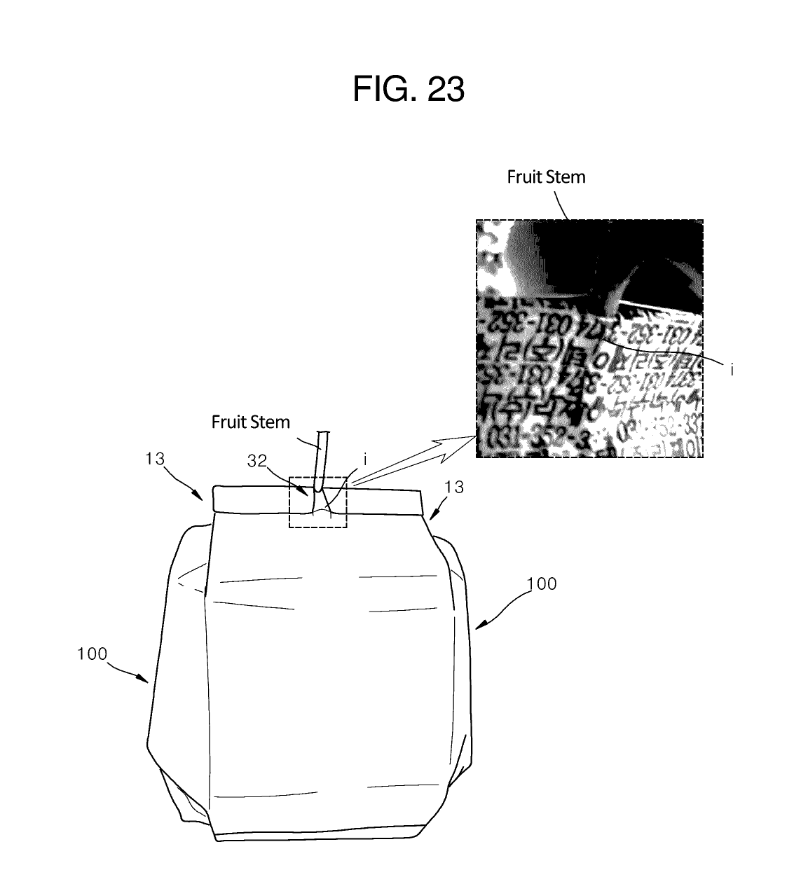

FIG. 23 is a perspective view showing the state wherein the fruit packed with the fruit bag according to the present invention becomes matured. At this time, the portion around the stem insertion portion 32 is enlargedly illustrated through a photograph. For example, the fruit bag 100 is adopted for illustration, but of course, other fruit bags as suggested above may be adopted.

As shown in FIG. 23, the matured state of the young fruit packed with the fruit bag 100 has the following characteristics. Firstly, if the young fruit becomes matured, the matured state of the young fruit is just reflected on the fruit bag 100. That is, the front surface 11, the back surface 12 and the multiple folding portions 16 of the side surfaces 13 are all expanded. However, the multiple folding portions 16 around the opening part 20 are attached to the fruit bag 100, without being expanded. This is because the grasping portions 20b of the opening part 20 serve as the hinges together with the multiple folding portions 16. The front surface 11 is flattedly maintained in the state where the opening part 20 is attached thereto, without having any wrinkles or deformation. Accordingly, the cover 30 around the stem insertion portion 32 into which the fruit stem is inserted becomes in a swollen state i in such a manner as to come into close contact with the fruit stem (See the enlarged photograph). The state exists from the time when the young fruit is inserted. Like this, if the fruit stem comes into close contact with the cover 30, worms or foreign matters do not enter the fruit bag 100.

As set forth in the foregoing, the fruit bag and the method for manufacturing the same according to the present invention are provided with the band type opening part that is attached to the entrance thereof and opens the internal space of the fruit bag to allow the entrance to be expanded if a pressure is applied to the side surfaces thereof, whereby the fruit bag is capable of being simply configured to provide economical advantages, easily ensuring a space in which fruit grows, providing a light weight to prevent falling together with the fruit, and preventing the surfaces of young fruit and matured fruit packed therewith from being damaged. Further, the fruit bag according to the present invention is configured to allow the entrance to be packed with the cover, thereby preventing rainwater or foreign matters from entering the fruit bag. Furthermore, the fruit bag according to the present invention is configured to have the band type opening part made of the biodegradable material, thereby being collected together with the fruit bag to prevent soil from being polluted. Moreover, the fruit bag according to the present invention is configured to prevent wrinkles and deformation from occurring thereon, to allow the cover to be attached at a right position, to form no space into which foreign matters move, and to permit the attaching force to be still maintained even though time goes by.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fruit bag having a body and an entrance formed on the body to insert young fruit thereinto, the body having a front surface, a back surface, and side surfaces, the fruit bag comprising:
a cover protruding from the front surface to cover the entrance and having a stem insertion portion formed thereon, the stem insertion portion having a cut portion formed by means of cutting the cover;
multiple folding portions formed by folding each side surface at least one or more times; and
an opening part attached to the form of a band to the end portion of the body forming the entrance and having flat portions attached to the front surface and the back surface and grasping portions attached to the side surfaces, the grasping portions forming hinges together with the multiple folding portions so that if a pressure is applied to the grasping portions, the entrance is expanded by means of the flat portions.

2. The fruit bag according to claim 1, wherein the cover is extended from the back surface.

3. The fruit bag according to claim 1, wherein the cover is formed unitarily with the opening part.

4. The fruit bag according to claim 1, wherein the opening part defines a folding line along which the cover is folded.

5. The fruit bag according to claim 1, wherein the opening part is attached to the body wrinkled and deformed when the pressure is applied to the body.

6. The fruit bag according to claim 1, wherein the distance between the front and rear side grasping portions becomes expanded toward the starting points of the grasping portions from the end portion thereof.

7. The fruit bag according to claim 1, wherein the opening part has a ruled line formed on the grasping portion and an expansion portion extended from the portion in which the ruled line is formed.

8. The fruit bag according to claim 1, wherein the stem insertion portion has a stem insertion hole connected to the slantly formed cut portion to insert the stem of the young fruit thereinto.

9. The fruit bag according to claim 8, wherein the opening part has an extension portion extended therefrom, the extension portion having a hole formed thereon to allow the stem insertion hole to be located thereinto.

10. The fruit bag according to claim 1, wherein the opening part has a bonding portion formed on the flat portion of the front surface thereof and a release layer formed on the flat portion of the back surface thereof.

11. The fruit bag according to claim 10, further comprising a glove used to pack the young fruit with the fruit bag in such a manner as to be coated with a release material on the figure portions thereof.

12. The fruit bag according to claim 1, wherein the cover has bonding portions formed thereon and the opening part has a release layer formed on the flat portion of the front surface thereof.

13. The fruit bag according to claim 12, wherein when the cover is bonded to the front surface, the flat portion of the front surface of the opening part is located at the inside of the bonding portions.

14. A fruit bag having a body and an entrance formed on the body to insert young fruit thereinto, the body having a front surface, a back surface, and side surfaces, the fruit bag comprising:
a cover protruding from the front surface to cover the entrance and having a stem insertion portion formed thereon, the stem insertion portion having a cut portion formed by means of cutting the cover;
multiple folding portions formed by folding each side surface at least one or more times and serving as hinges in such a manner as to be bonded to the front surface and the back surface; and
an opening part attached to the form of a band to the end portion of the body forming the entrance and having flat portions attached to the front surface and the back surface in such a manner as to place the side surfaces therebetween,
wherein the portions of the flat portions coming into contact with the side surfaces form grasping portions, and if a pressure is applied to the grasping portions, the entrance is expanded by means of the flat portions.

15. The fruit bag according to claim 14, wherein the opening part has a bonding portion formed on the flat portion of the front surface thereof and a release layer formed on the flat portion of the back surface thereof.

16. The fruit bag according to claim 15, further comprising a glove used to pack the young fruit with the fruit bag in such a manner as to be coated with a release material on the figure portions thereof.

17. The fruit bag according to claim 14, wherein the cover has bonding portions formed thereon and the opening part has a release layer formed on the flat portion of the front surface thereof.

18. The fruit bag according to claim 17, wherein when the cover is bonded to the front surface, the flat portion of the front surface of the opening part is located at the inside of the bonding portions.

19. A method for manufacturing a fruit bag, the method comprising the steps of:
manufacturing an original fruit bag having a cover;
forming multiple folding portions on side surfaces of the original fruit bag, a body having a front surface, a back surface, and side surfaces, and an entrance formed on the body to insert young fruit thereinto;
forming bonding portions on the cover or the front surface;
attaching a band type opening part to the end portion of the body forming the entrance, the opening part having flat portions attached to the front surface and the back surface and grasping portions bonded to or contacted with the side surfaces; and
forming a cut portion by cutting a portion of the cover extended from the back surface.

20. The method according to claim 19, further comprising the step of forming a stem insertion hole connected to the cut portion to insert the stem of the young fruit thereinto.

21. The method according to claim 19, further comprising the step of bonding the multiple folding portions to the front surface and the back surface.

22. The method according to claim 19, further comprising the step of forming a release layer on at least any one of the flat portion of the front surface of the opening part and the flat portion of the back surface of the opening part.

23. A method for manufacturing a fruit bag, the method comprising the steps of:
manufacturing an original fruit bag;
forming multiple folding portions on side surfaces of the original fruit bag, a body having a front surface, a back surface, and side surfaces, and an entrance formed on the body to insert young fruit thereinto;
forming an opening structure having a band type opening part and a cover extended from the opening part to cover the entrance, the opening part having flat portions and grasping portions;
attaching the opening structure to the form of a band to the end portion of the body forming the entrance, the flat portions being attached to the front surface and the back surface and the grasping portions being bonded to or contacted with the side surfaces; and
forming a cut portion by cutting a portion of the cover.

24. The method according to claim 23, further comprising the step of forming a stem insertion hole connected to the cut portion to insert the stem of the young fruit thereinto.

25. The method according to claim 23, further comprising the step of bonding the multiple folding portions to the front surface and the back surface.

26. The method according to claim 23, further comprising the step of forming a release layer on at least any one of the flat portion of the front surface of the opening part and the flat portion of the back surface of the opening part.
